(19) United States
(12) Patent Application Publication
(10) Pub. No.: US 2012/0302091 A1
(43) Pub. Date: Nov. 29, 2012

(54) WIRING SYSTEM WITH ELECTRICAL DEVICE, BOX, AND MODULE

(76) Inventor: Lenny Grissom, St Petersburg, FL (US)

(21) Appl. No.: 13/114,373

(22) Filed: May 24, 2011

(51) Int. Cl. H01R 13/60

(52) U.S. Cl. 439/535

(57) ABSTRACT

A color-coded wiring system for electrical devices such as outlets, switches, lighting fixtures, ceiling fans, smoke detectors, thermostats, chimes, etc. is described. For residential structures, the wiring system is comprised of an electrical device, a box with two open sides, and a module. The back side of the electrical device comprises at least one male plug and the front side comprises at least one female outlet receptacle. The male plug(s) inserts into the female outlet receptacle(s) through the open sides of the box. The back, top, or bottom side of the module has a section(s) comprising at least two stab holes. At least one female outlet receptacle is continuous with at least one stab hole. For commercial structures, the commercial box is open on only the side facing the electrical device, comprises knockouts for wires to enter through conduits, and front and back stops to hold the module in place.

### CROSS-REFERENCE TO RELATED APPLICATION

None

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to the field of electrical wiring, in particular, electrical wiring of electrical devices such as lighting fixtures, outlet receptacles, switches, ceiling fans, chime boxes, and thermostats in a box.

Lighting fixtures, outlet receptacles, switches, ceiling fans, smoke detectors, chimes, thermostats, and the like require a power source to function. In conventional electrical wiring systems, three wires are used, a white wire, a black wire, and a ground (or green) wire. To take an example, U.S. Pat. No. 5,266,039 to Boyer depicts a typical outlet receptacle (FIG. 1). Two screws on each side of the outlet receptacle receive a white wire and black wire, respectively. A third screw (not shown) receives the ground wire.

All these wires are inserted in a box along with the electrical device and typically enclosed by a cover plate. An example of this can be seen in U.S. Pat. No. 6,191,361 to Matty, which depicts an electrical outlet receptacle connected to three wires (black, white, ground) and inserted into a box.

Another example is a lighting fixture such as in U.S. Pat. No. 4,590,544 to Decandia which depicts a lighting fixture with two wires (black and white) that are connected by wire nuts to two other wires (black and white) protruding from a stab hole. These wires are all inserted into a box in a wall or ceiling.

The problem with the conventional system for wiring electrical devices in a wall or in a ceiling is the danger posed by numerous wires shoved into a box or crammed with an electrical device, as well as the risk of miss-wiring devices. Moreover, live electrical wiring and screws tend to be exposed inside the box, and wires are twisted together with wire nuts that can come loose. Most electrical distribution fires result from problems with “fixed wiring” such as faulty electrical outlets and old wiring. As a result, over 400 people are electrocuted annually due to faulty or defective electrical wiring and electrical devices, or by coming in contact with wires or device screws, according to the United States Consumer Product Safety Commission.

Light fixtures and lamps/light bulbs are also leading causes of electrical fires.

Many avoidable electrical fires can be traced to misuse of electric cords, such as overloading circuits, poor maintenance, and running the cords under rugs or in high traffic areas.

The U.S. Consumer Product Safety Commission suggests that strategies for eliminating childhood electrocution should concentrate on ensuring safe domestic environments with properly maintained electrical devices.

The National Energy Code seeks to prevent electrical shock with various mandates.

Among them are to prevent the over-filling of boxes and electrical receptacle devices, properly matching 14 gauge wires to 15 amp circuits and 12 gauge wires to 20 amp circuits, avoiding improper wiring of switches, and safeguarding against the installation of electrical devices upside down.

Thus, the objective of the present invention is to create a new electrical wiring system for electrical devices installed in boxes and inserted in walls and ceilings, both for residential and commercial structures, that comprise boxes that are completely sealed, that avoid the overloading of circuits, overfilling of boxes and devices, that eliminates excessive wires stuffed in boxes and crammed with electrical devices, and reduces the risk of improper installation.

The objective is achieved in the case of residential structures by way of a wiring system comprised of an electrical device, a box with two open sides, and a module, wherein the back side of the electrical device comprises at least one male plug and the front side of the module comprises at least one female hole, wherein the at least one male plug inserts into the at least one female outlet receptacle through the open sides of the box when the electrical device, box, and module are joined together, wherein the back side of the module comprises multiple stab holes, and wherein at least one female hole is continuous with at least one stab hole.

In the case of commercial structures, the objective is achieve by way of a wiring system an electrical device, a box with one open side, and a module, wherein the back side of the electrical device comprises at least one male plug that insert into the front side of the module comprising at least one female outlet receptacle, wherein the box encloses the module through the open side of the box, wherein the box comprises empty space between the module and the back of the box in which wires enclosed in a conduit may be inserted, wherein the box comprises a hole to accept the conduit through which wires may enter and exit, wherein the back side of the module comprises multiple stab holes, and wherein at least one female outlet receptacle of the module is continuous with at least one stab holes of the module.

### SUMMARY

The present invention is a wiring system for electrical devices such as outlets, switches, lighting fixtures, ceiling fans, smoke detectors, thermostats, chimes, etc. In the case of residential structures, the wiring system is comprised of an electrical device, a box with two open sides, and a module, wherein the back side of the electrical device comprises at least one male plug and the front side of the module comprises at least one female outlet receptacle, wherein the at least one male plug inserts into the at least one female outlet receptacle through the open sides of the box when the electrical device is joined with the module through one side of the box and the module is joined to electrical device through the other side of the box, wherein the back, top, or bottom side of the module comprises at least one section comprising at least two stab holes, and wherein at least one female outlet receptacle is continuous with at least one stab hole.

For commercial structures, the box is open on only the side facing the electrical device, comprises knockouts for wires to enter through conduits, and front and back arms to hold the module in place. To avoid improperly installation, the invention utilizes a color coding system as well as indicia to indicate proper positioning.

### DRAWINGS

FIG. 1 depicts the basic design for the invention, comprising an electrical device, a box with two sides comprising a flange, and a module.

FIG. 2 illustrates the electrical device, box, and module all joined together with the electrical device and module inserted over both sides of the box and separated by the flange, the entire system is inserted behind a drywall or ceiling.

FIG. 3 shows the front view of the invention with indicators on the edges of the flange to avoid confusion.

FIG. 4 shows a cross-sectional view of the invention behind a drywall, with the module, box, and electrical device parallel to a stud, wherein breezeways are visible.

FIG. 5 shows a side view of the box where ridges are present on each side, either on the inside or outside to assist with joining the module and electrical device to the box.

FIG. 6 shows a cross-sectional side view of the module with three stab holes in the back side and one female outlet receptacle on the front side.

FIG. 7 shows a cross-sectional side view of the module with five stab holes in the back, in which two of the stab holes share the same female outlet receptacle, and the rest of the female outlet receptacles are continuous with a stab hole.

FIG. 8 depicts various types of modules for different types of electrical devices and power sources, color coded to make installation easier.

FIG. 9 depicts an example of a front view of a module, in this case a 15 Amp Arc Fault Outlet

FIG. 10 depicts another example of a front view of a module, in this case a 15 Amp Switch, with four sets of female outlet receptacles

FIG. 11 depicts a back side view of an exemplary module with three sections of stab holes

FIG. 12 depicts a back side view of another exemplary module with five sections of stab holes

FIG. 13 depicts a close up cross-sectional, side view of a module in which a female outlet receptacle on the front side of a module is continuous with a stab hole on the back side of the module.

FIG. 14 depicts the back view of an electrical device, in particular, a 15 AMP outlet device

FIG. 15 depicts the back view of an electrical device, in particular, a 15 amp switch which is also color coded.

FIG. 16 depict the side view of two different electrical devices, one with two male plugs and the other with four

FIG. 17 shows the front view of a cover plate for an outlet.

FIG. 18 shows the front view of a cover plate for a switch.

FIG. 19 shows a side view of a box with the flange in the front and screws that insert into a pre-existing box used for retrofitting an existing wiring system

FIG. 20 shows a side view of the box of FIG. 19, with the electrical device and module attached to the box, all of which (with the exception of the cover plate) are inserted into the preexisting box

FIG. 21 is the front view of FIG. 19 showing placement of the screw holes on the flange and the position of the pre-existing box

FIG. 22 shows an alternate embodiment of the box in the form of a pancake box also with two open sides and a circular flange

FIG. 23 shows the back side of the module for a pancake box

FIG. 24 shows the front side of the module for a pancake box

FIG. 25 shows an electrical device in the form of a connect adapter plate.

FIG. 26 is a top, cross-sectional view of the invention inserted behind a drywall.

FIG. 27 depicts an electrical device in the form of a ceiling fixture with a light ring 323.

FIG. 28 shows an electrical device 100 in the form of a smoke detector

FIG. 29 depicts the invention as used during the construction phase of a residential structure where the electrical device has no cover plate

FIG. 30 depicts a simple dome-shaped light fixture used during construction.

FIGS. 31-32 show a front and back view of a module used for a 220 volt outlet device for large appliances

FIG. 33 is the front view of the 220 volt outlet device into which a large appliance may be plugged.

FIG. 34 is a top view of the module for a 220 volt outlet device depicting the location of the stab holes.

FIG. 35 shows a side view of the invention in the form of a thermostat outlet.

FIG. 36 is the back view of a module for a thermostat outlet.

FIG. 37 shows a side view of the invention in the form of a chime box outlet.

FIG. 38 shows the back view of a transformer module

FIG. 39 shows the front view of a chime module with female outlet receptacles and pushbutton female outlet receptacles

FIG. 40 shows a push button.

FIG. 41 shows an alternate embodiment of the invention for commercial structures

FIG. 42 shows the rear of the commercial box

FIG. 43 shows a top view of the commercial box.

FIG. 44 show a front view of the invention for commercial structures and a side view of the front and back stops

### DESCRIPTION

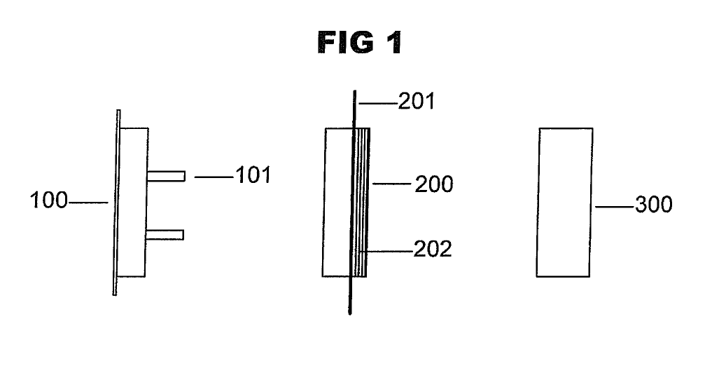

FIG. 1 shows a side view of the three parts of the invention, namely, an electrical device 100, a box 200, and a module 300. The electrical device 100 can be an outlet, a switch, a lighting fixture, a ceiling fixture (e.g., fan, chandelier, smoke detector), a smoke detector, a thermostat, a chime, a push button, an electrical adaptor plate, etc. The electrical device comprises at least one male plug 101. The box of FIG. 1 is designed for residential structures and comprises two open sides and a flange 201 located preferably in the center that divides the box into two sides. Each side of the box comprises ribs 202 on the inside or outside so that the electrical device and module can snap into place when the electrical, box, and module are joined together. The module preferably comprises indicia indicating its top side to ensure proper insertion into the box.

In a preferred embodiment, the width of the box is 1¼ inches and the module is 1½ inches, with approximately 1¼ inches of the electrical device being inserted into the box. The height of the electrical device is preferably 2½ inches, the box is preferably 2¼ inches high, and the module is preferably 3 inches high.

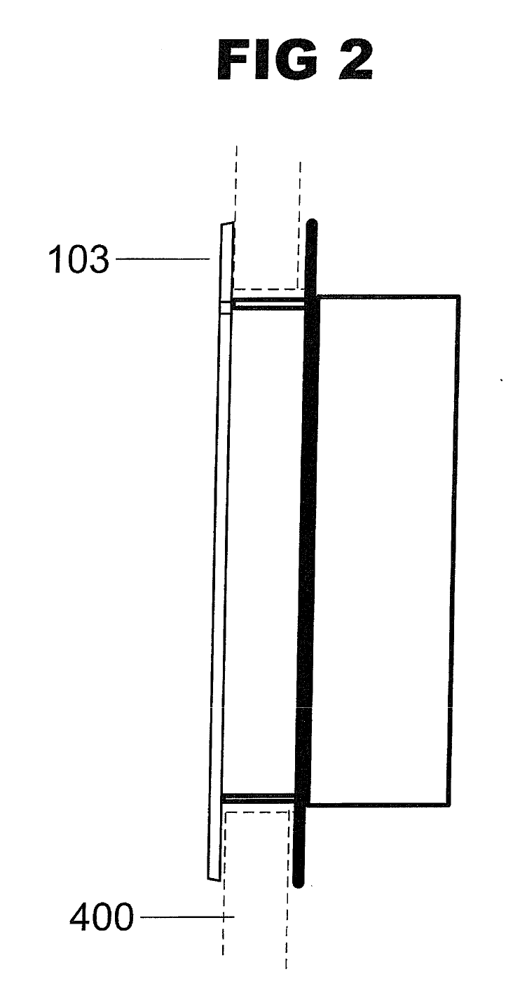

FIG. 2 shows an electrical device in the form of an outlet or switch with a cover plate 103 over a dry wall 400. The electrical device 100, box 200, and module 300 are all joined together with the flange 201 separating the outside surface of the electrical device and module. The combined width of the electrical device, box, and module inside the drywall should be 2¼ inches.

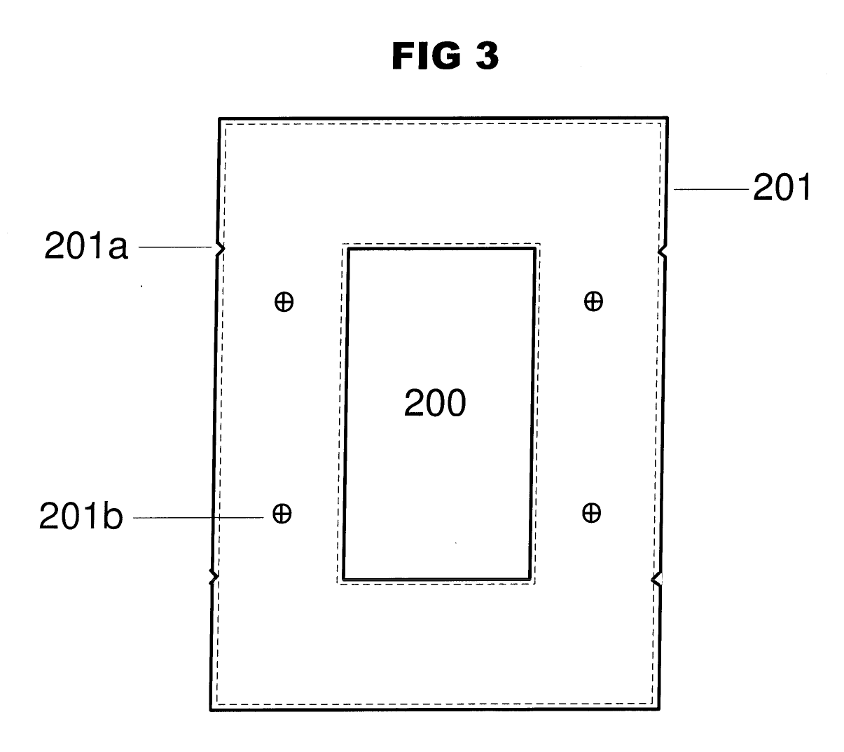

FIG. 3 is a front view of the box 200 and flange 201. The flange comprises V-shaped crimps 201a on the left and right sides of the flange to mark the top and bottom of the box in order to assist installer when attaching the box 200 to a stud. The flange 201 further comprises four ⅛ inch holes 201b for 1″×#8 screws that can attach to wood or metal. A pair of screws is screwed into a stud and the other pair is screwed into open space so that they are not in the way of the drywall. The dotted lines represent foam attached to the flange to assist in blocking breezeways 702.

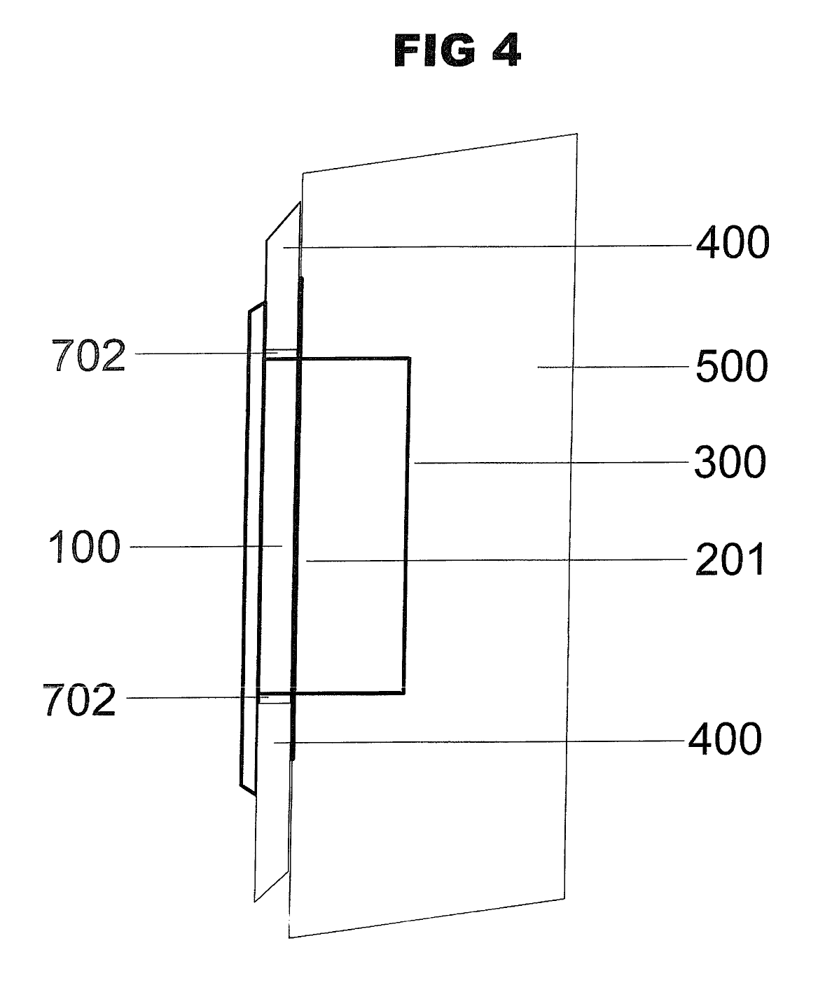

FIG. 4 is a cross-sectional view of the invention behind a drywall, with the module 300 and electrical device 100 parallel to a stud and perpendicular to a drywall 400, wherein breezeways 702 are visible between the electrical device 100 and drywall 400. Air entering a residential structure from the attic through breezeways 702 result in higher energy bills; thus creating the need to seal the breezeways 702 by way of a flange with foam insulation.

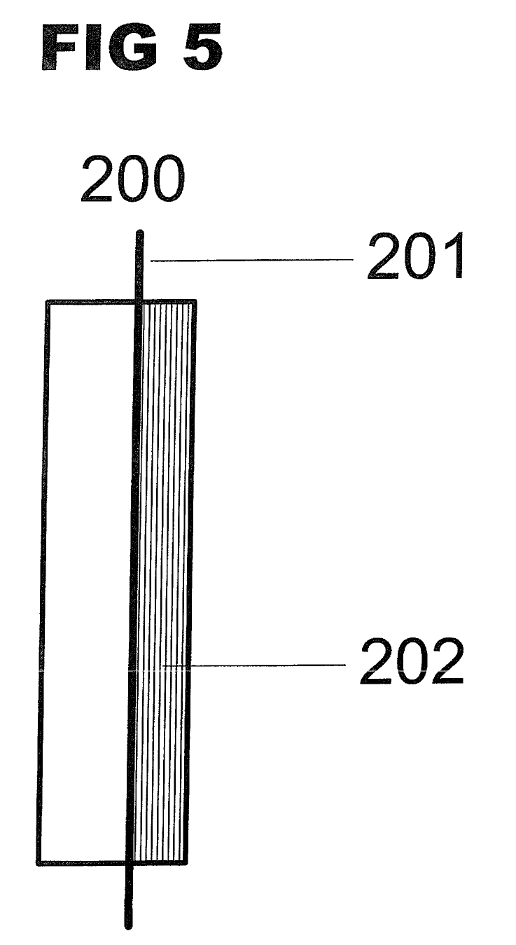

FIG. 5 is a side view of a box 200 for residential structures. The right side of the box (right of the flange) show ribs 202 so that the module 300 may snap onto the box 200. The left side of the box has ribs on the inside (not shown).

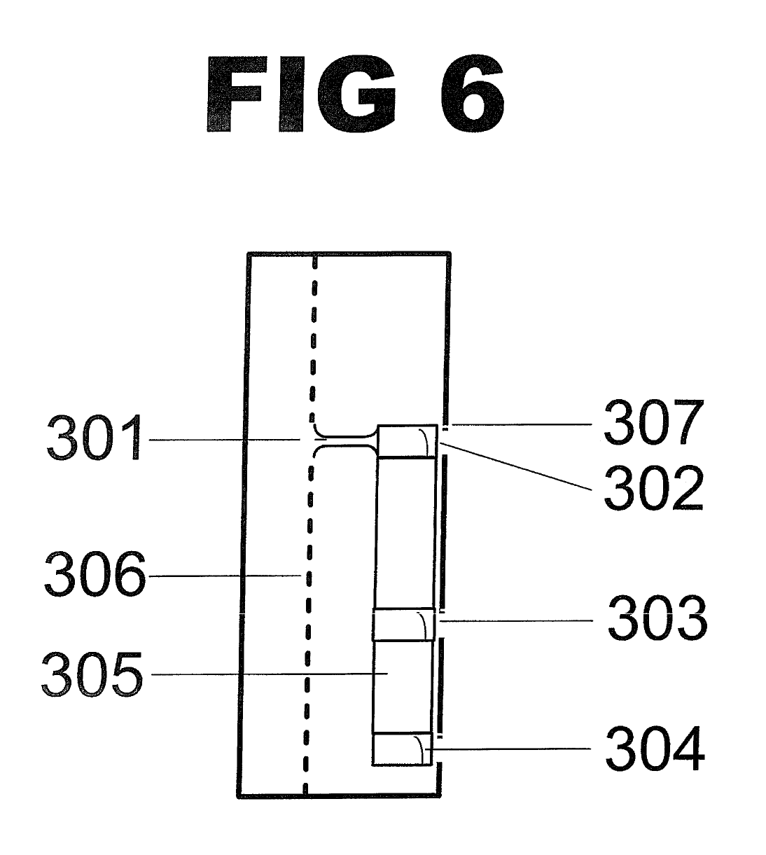

FIG. 6 shows a cross-sectional side view of a module 300 comprised of one female outlet receptacle 301 and three stab holes 302, 303, 304. The female outlet receptacle 301 is continuous with one of the stab holes 302 which receive power (“Power-In” stab holes). The Power-In stab hole 302 is large enough to receive a #14 wire for a 15 amp circuit and but too small to receive a #12 wire for a 20 amp circuit. Stab hole 303 loops to the next outlet opening (“Loop to Next Outlet” stab hole”). The Loop to Next stab hole 303 is large enough to receive a #12 wire for a 20 amp circuit (but too large for a #14 wire) and is connected to a copper or aluminum power wire strip 305 that connects to the Power-In stab hole 302. Stab hole 304 is intended for “old work” (“Old Work” stab hole) meaning that in the future another device can be added to a residential structure by inserting a wire into the Old Work stab hole 304 to receive power. The Old Work stab hole 304 is large enough to receive a #14 wire for a 15 amp circuit but too small to receive a #12 wire for a 20 amp circuit. The Old Work stab hole 304 is connected to the Loop to Next Outlet stab hole 303 via a copper or aluminum power wire strip 305. A solid plastic or metal wall 306 separates the stab holes from the front of the module, with the exception of the female outlet receptacle 301. A slot 307 exists in the back of the module into which a tool may be inserted to release stabbed wire. In each of the stab holes, there is a cooper or aluminum wire insert.

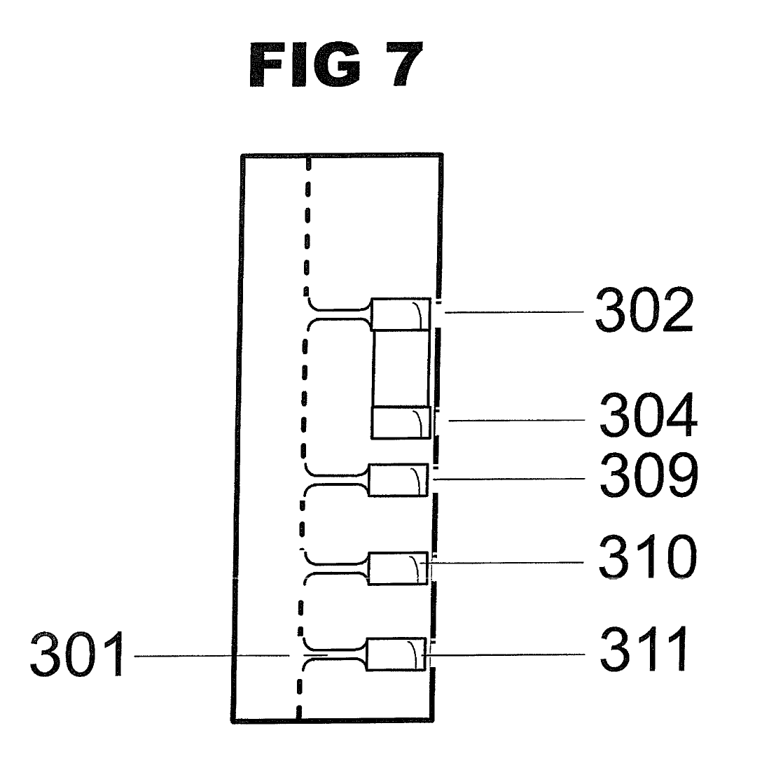

FIG. 7 shows an alternate embodiment of a module 300. Here, there are four female outlet receptacles 301 and five stab holes 302, 304, 309, 310, 311. Stab hole 309 in intended for a first light fixture and is large enough to receive a #14 wire for a 15 amp circuit and large enough to receive a #12 wire for a 20 amp circuit. Stab holes 309, 310, and 311 are continuous with female outlet receptacles 301. However, stab hole 304 shares a female outlet receptacle with stab hole 302. Stab hole 310 is intended for a second light fixture and is large enough to receive a #14 wire for a 15 amp circuit, but not a #12 wire for a 20 amp circuit. Stab hole 311 is intended for a switch for an outlet.

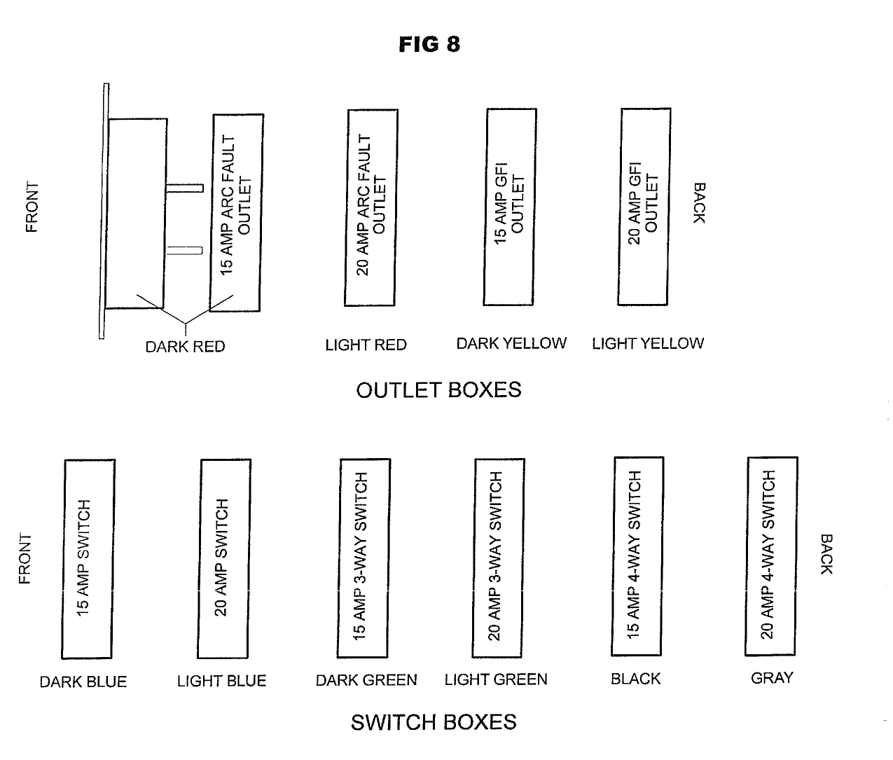

FIG. 8 shows an example of how both the module and electrical device are color coded to correspond with each other. A color is designated for each type of module, for example, a 20 amp arc fault outlet is light red, while a 20 amp 4-way switch is gray. An electrical device that is compatible with a 20 amp arc fault outlet would also be red, while an electrical device that is compatible with a 20 amp 4-way switch would also be gray. This matching of colors facilitates installation. The color matching system also ensures that the right module is matched with a given electrical device.

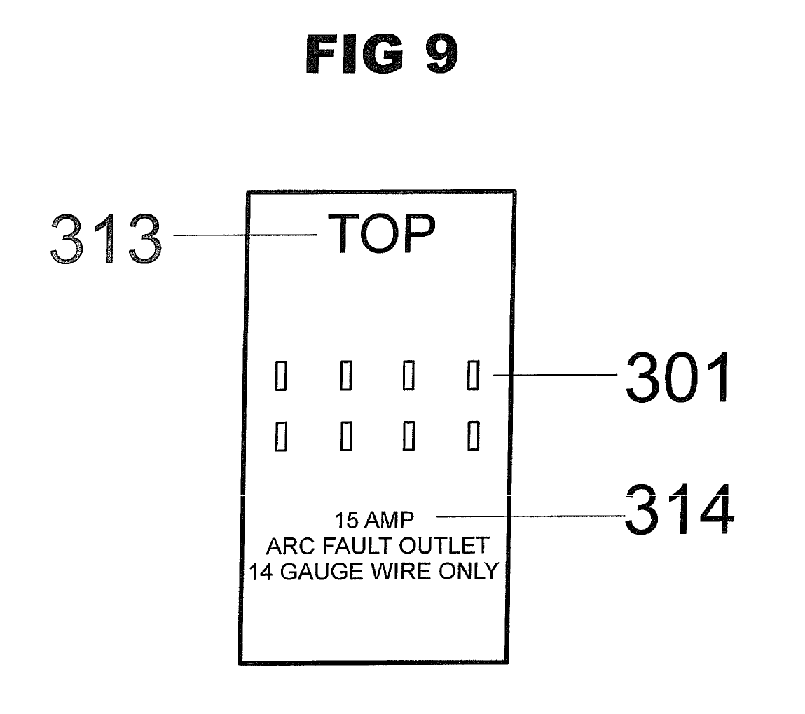

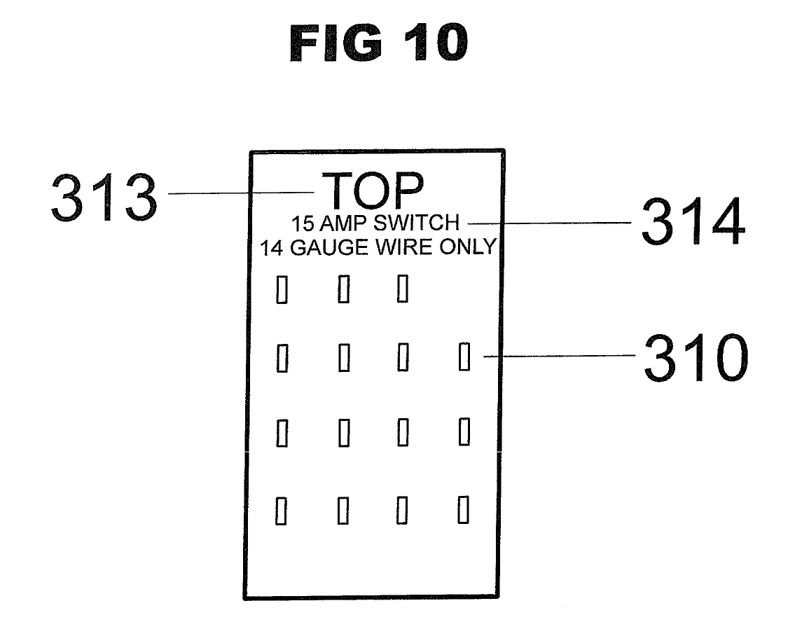

FIG. 9 shows a front view of an exemplary module which is designed to avoid matching an electrical device with the wrong type of wire, and also to avoid matching an electrical device with the wrong type of module. The female outlet receptacles 301 are positioned and configured to ensure that only the corresponding electrical device can be joined with the module 300. Also, the module comprises indicia indicating the top side 313 of the module and the module type 314. While FIG. 9 is a module for a 15 amp arc fault outlet, FIG. 10 is a module for a 15 amp switch. The four rows of female outlet receptacles 301 correspond to an electrical device in the form of a switch with multiple switches or outlets.

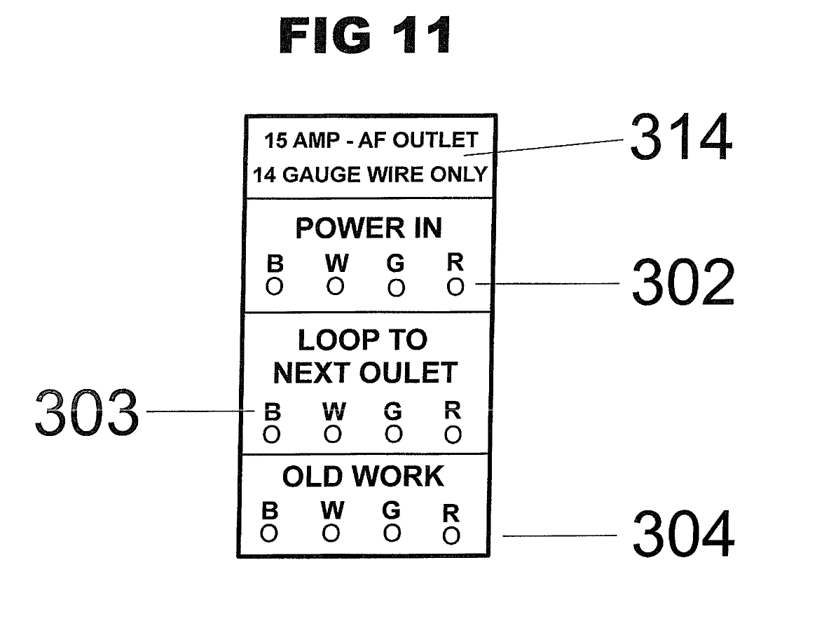

FIG. 11 shows the back side of an exemplary module for an outlet. Here, there are three sections comprising four stab holes in each section. The first section comprises Power-In stab holes 302, the second section comprises Loop to Next Outlet stab holes 303, and the third section comprises Old Work stab holes 304. In each row of stab holes 302, 303, 304, there is a stab hole for a black wire (B), a white wire (W), a ground wire (G), and a red wire (R).

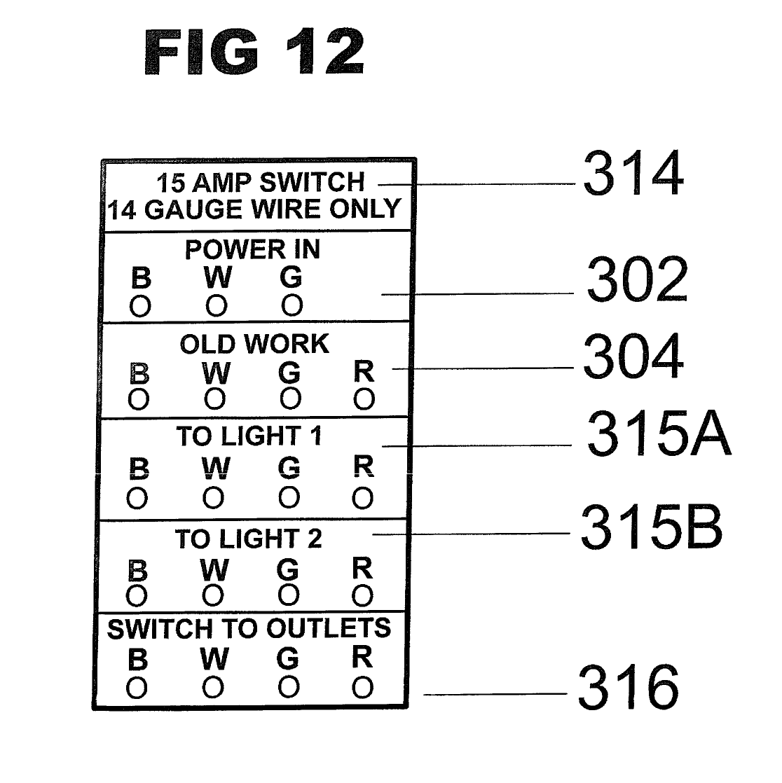

FIG. 12 shows another exemplary module for a switch. Unlike FIG. 11, the module for a switch may have five sections. The first section comprises Power-In stab holes 302, but only three B, W, G. The stab hole for an R wire is intended to operate a secondary electrical mechanism, such as a light fixture with a ceiling fan, and is therefore an accessory stab hole. The second section comprises Old Work stab holes 304. The third and fourth section comprises outlets for light fixtures 315a, 315b. The fifth section comprises Switch to Outlets stab holes 316 intended for a switch that controls the electrical current the outlets for light fixtures 315a, 315b.

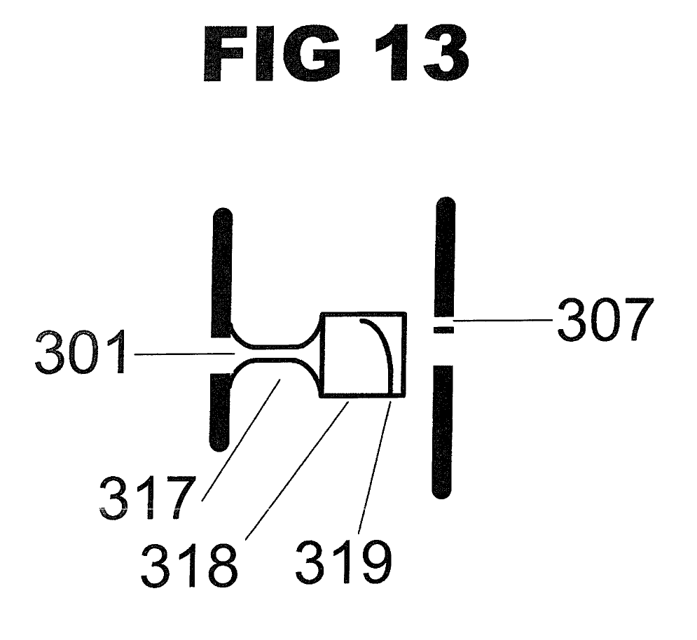

FIG. 13 is a close-up view of a female outlet receptacle continuous with a stab hole. A copper or aluminum clip 317 receives the male plug 101 of an electrical device 100. A copper or aluminum insert 318 receives a stabbed wire, and a copper or aluminum arm 319 pinches and holds a stabbed wire into the insert 318.

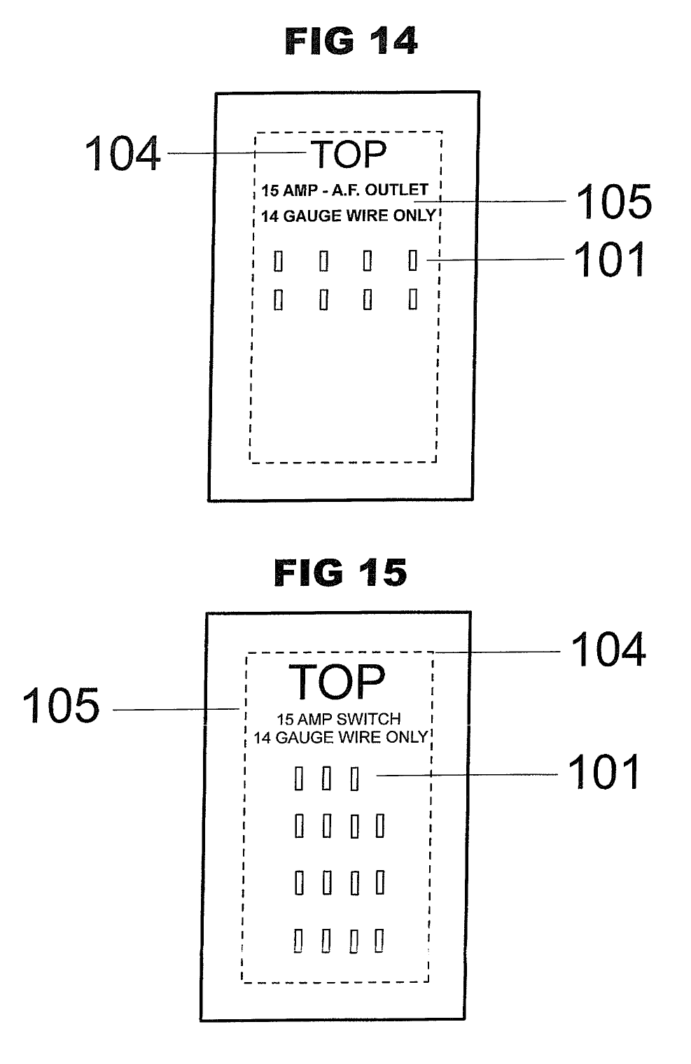

FIG. 14 is a back view of an electrical device, in this case an outlet. The male plugs 101 are inserted into the female outlet receptacles 301. There are six different outlet devices as follows:
15 AMP
ARC FAULT OUTLET
14 GAUGE WIRE ONLY
20 AMP
ARC FAULT OUTLET
12 GAUGE WIRE ONLY
15 AMP
G.F.I. OUTLET
14 GAUGE WIRE ONLY
20 AMP
G.F.I. OUTLET
12 GAUGE WIRE ONLY

Like the module, the electrical device comprises indicia indicating the top side 104 of the module and the module type 105.

FIG. 15 is the back view of an electrical device, a 15 amp switch, which corresponds with the 15 amp switch module in FIG. 10. There are six different switch devices:
15 AMP SWITCH
14 GAUGE WIRE ONLY
20 AMP SWITCH
20 GAUGE WIRE ONLY
15 AMP 3-WAY SWITCH
14 GAUGE WIRE ONLY
20 AMP 3-WAY SWITCH
12 GAUGE WIRE ONLY
15 AMP 4-WAY SWITCH
14 GAUGE WIRE ONLY
20 AMP 4-WAY SWITCH
12 GAUGE WIRE ONLY

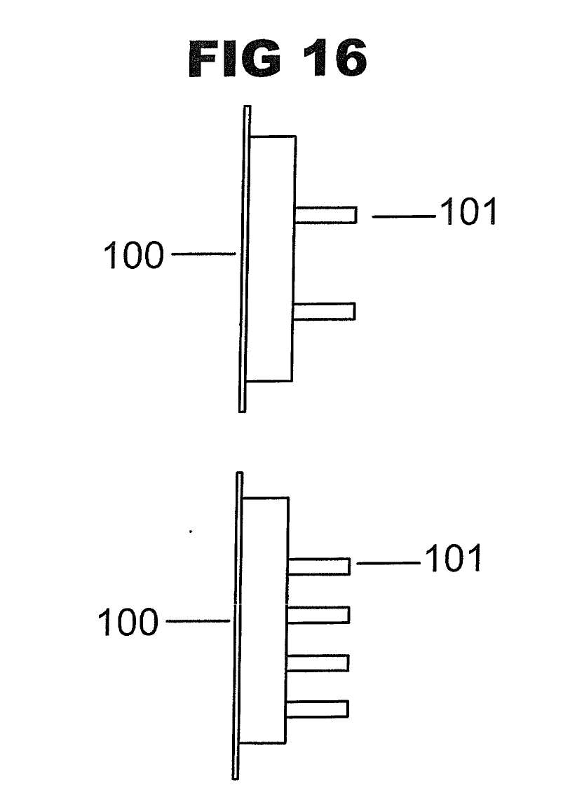

FIG. 16 depict the side view of two different electrical devices, one with two male plugs and the other with four.

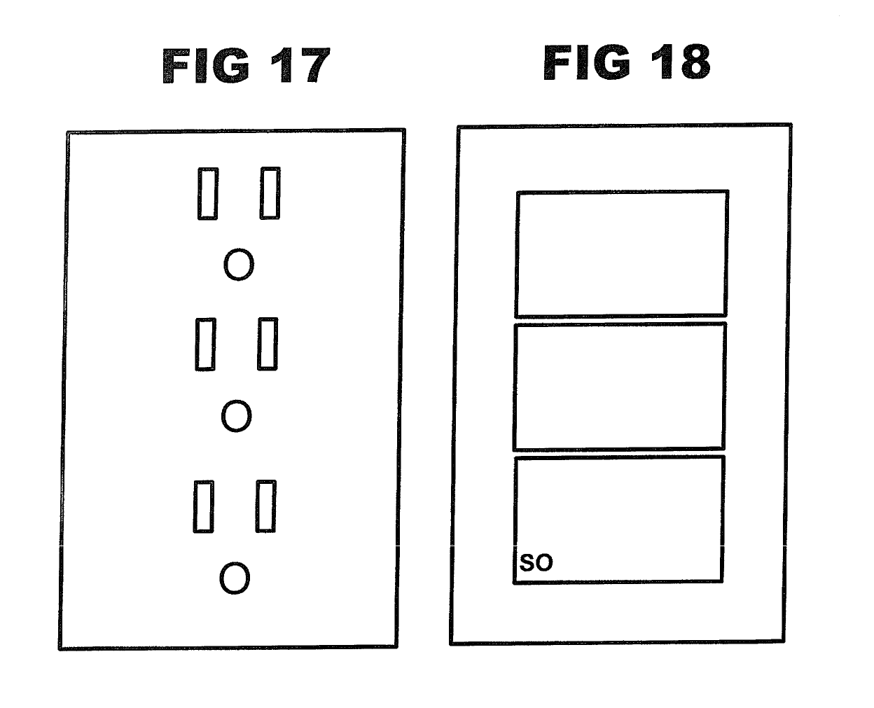

FIG. 17 shows the front view of a cover plate 103 for an outlet. FIG. 18 shows the front view of a cover plate 103 for a switch.

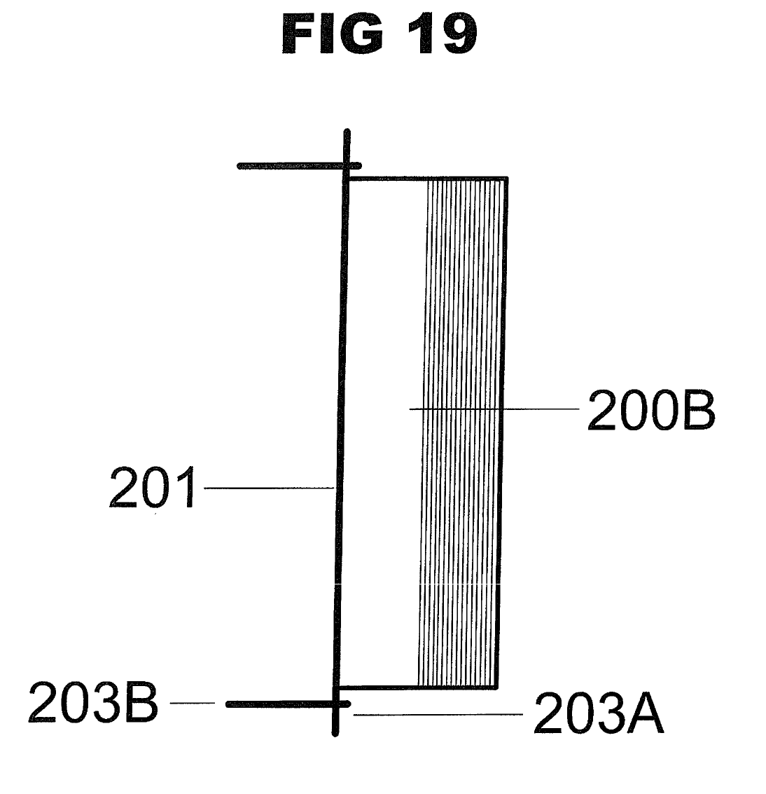

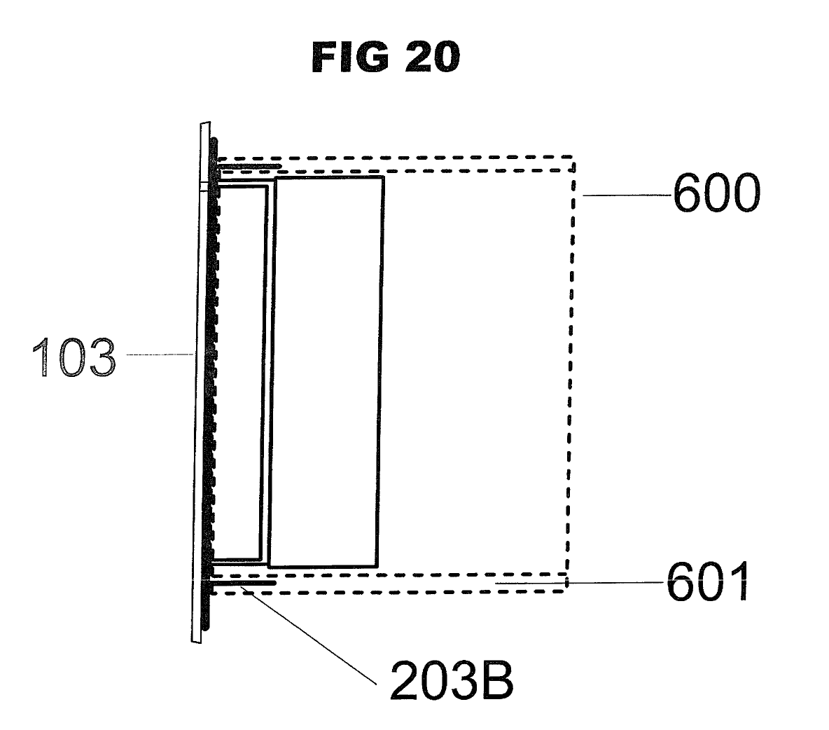

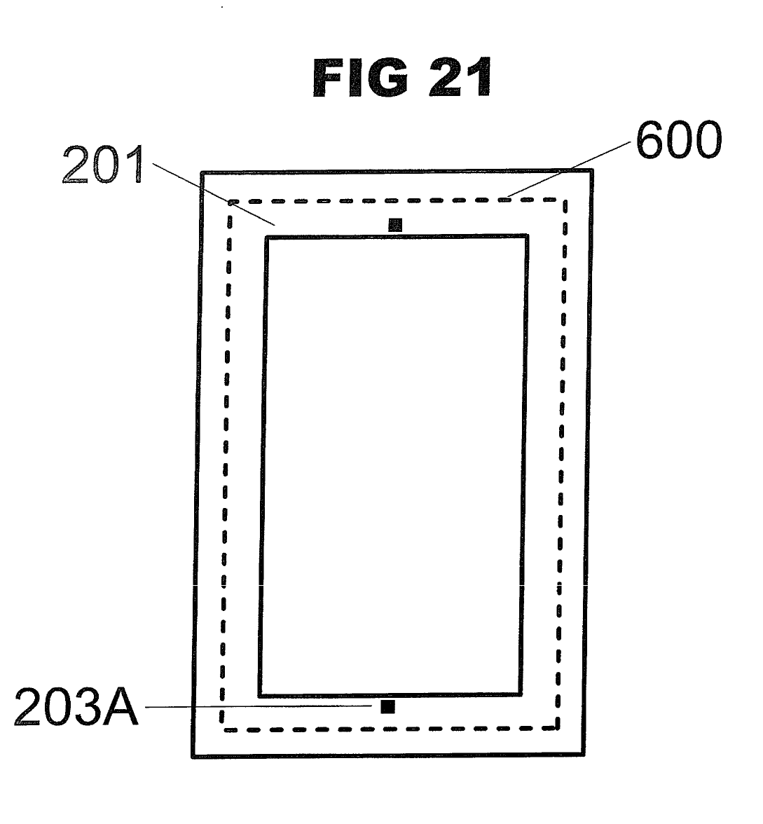

The present invention can be used to retrofit a pre-existing box 600. FIG. 19 shows a retrofit box 200a of the present invention in which the flange 201 is in the front of the retrofit box 200a. The flange comprises screw holes 203a that correspond with the screw holes 601 of the pre-existing box, so that the box can be screwed inside of the pre-existing box 600. FIG. 20 shows an electrical device joined with a retrofit box 200a and a module, all contained inside a pre-existing box 600, with the exception of the cover plate 103, and screwed into place via the screw holes 203a of the flange 201 of the retrofit box 200a. FIG. 21 shows a front view of the retrofit box 200a. Insulation on the flange 201 is on the back side (not shown).

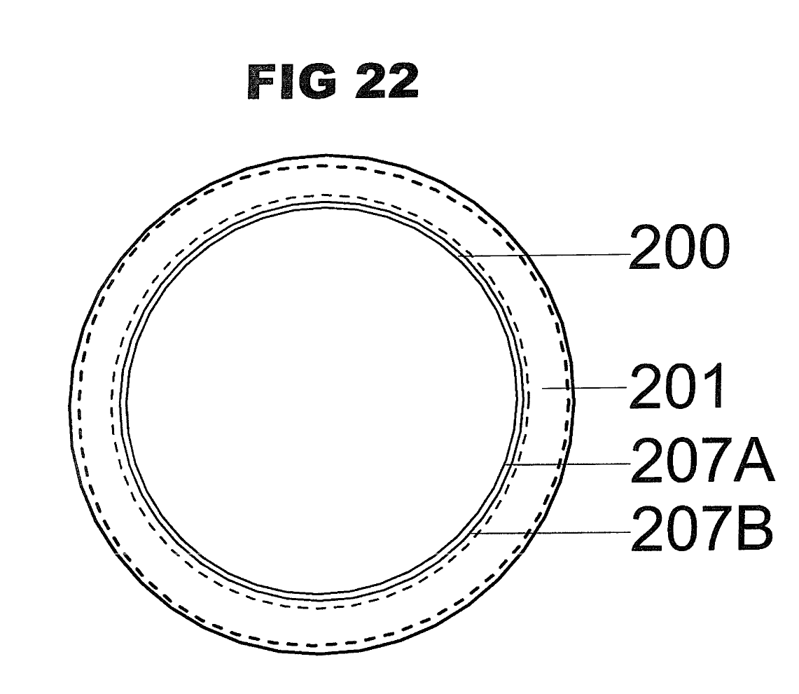

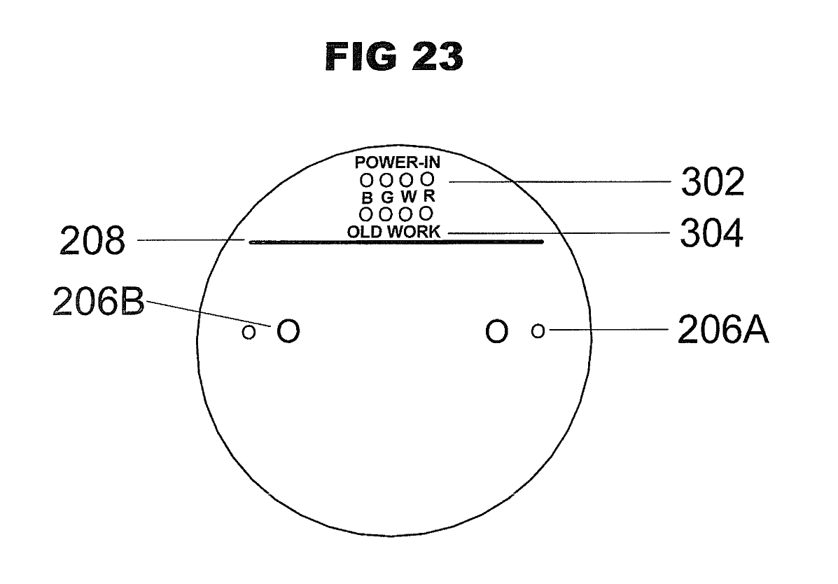

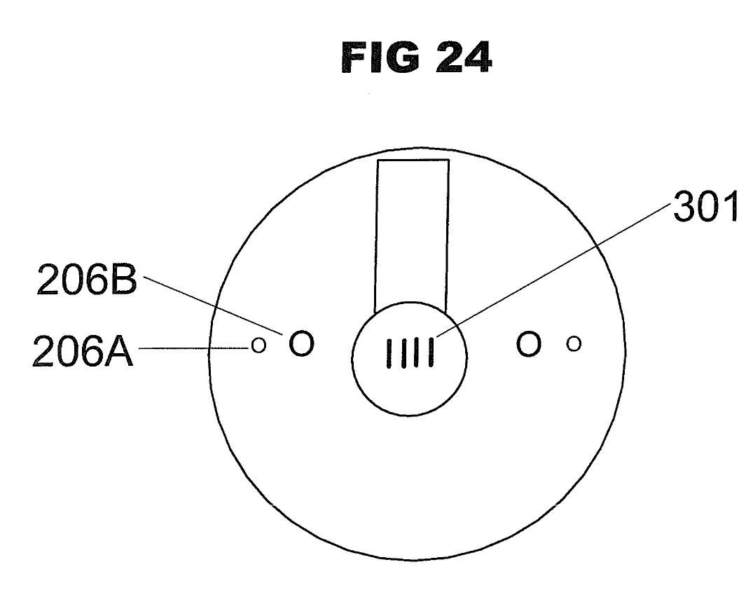

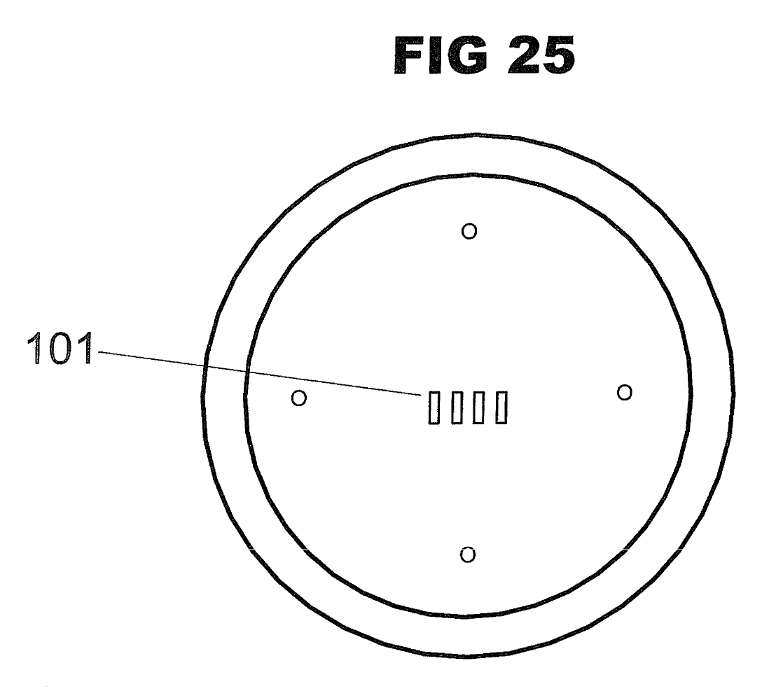

In the previous drawings, the box and flange was rectangular. Also, the box had openings on the front and back side. FIG. 22 shows an alternate embodiment of the box in the form of a pancake box 200 also with two open sides and a circular flange 201. However, in a preferred embodiment, the pancake box has an inner wall and an outer wall 207a, with the outerwall 207b comprising ribs 202. FIG. 23 shows the back side of the module 300 for a pancake box 200 which is also circular. There is only one section with Power-In stab holes 302 and Old Work stab holes 304. The pancake box and corresponding module is intended for use with ceiling fixtures (e.g., fans, chandeliers, smoke detectors, etc.). As such, there are two screw holes 206a with crimps (not shown) on the back wall of the pancake box to secure the module 300 to the electrical device 100 (lighting fixture) and two 206b larger screw holes on the back wall of the pancake box to attach a ceiling fan or heavy light fixture. There are also two additional flanges 208 perpendicular to the back side of the module. FIG. 24 shows the front side of the module 300. There are four female outlet receptacles 301. FIG. 25 shows an electrical device 100 in the form of a connect adapter plate. A connect adapter plate is often used as an adjunct of a switch or electrical outlet device. The connect adapter plate, like other electrical devices, attach to the module 300 through the box 200.

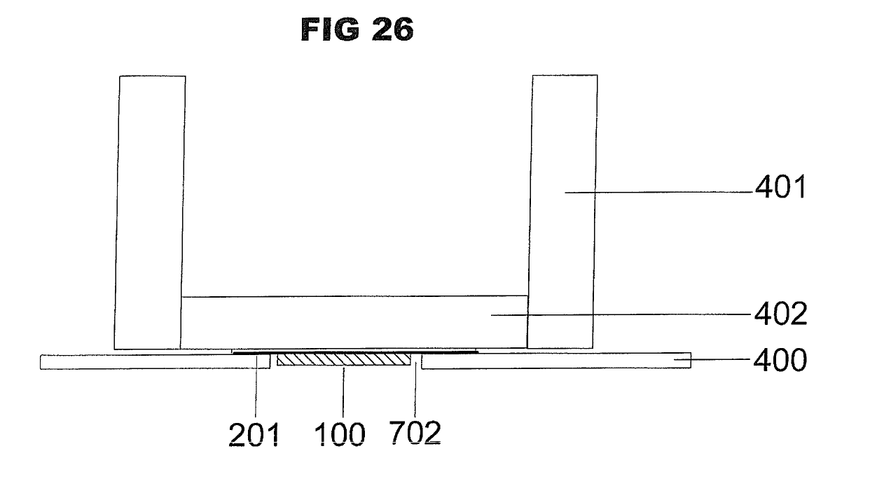

FIG. 26 is a top, cross-sectional view of the invention inserted behind a drywall. The flange 201 and foam (not shown) block air flow through air breezeways 702. Blocking air breezeways 702 reduces the amount of cold or warm air from entering a residential structure, helping the owner to reduce his electrical costs. FIG. 26 depicts two trusses 401 and a nail block 402.

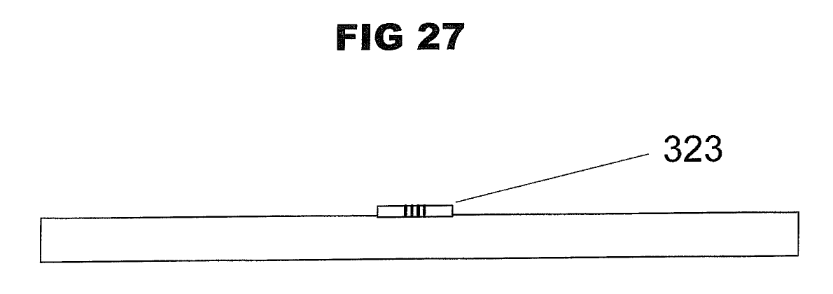

FIG. 27 depicts an electrical device in the form of a ceiling fixture with a male plug 101 in the form of a light ring 101a. The light ring 101a is the portion of the electrical device that connects to the module through the box.

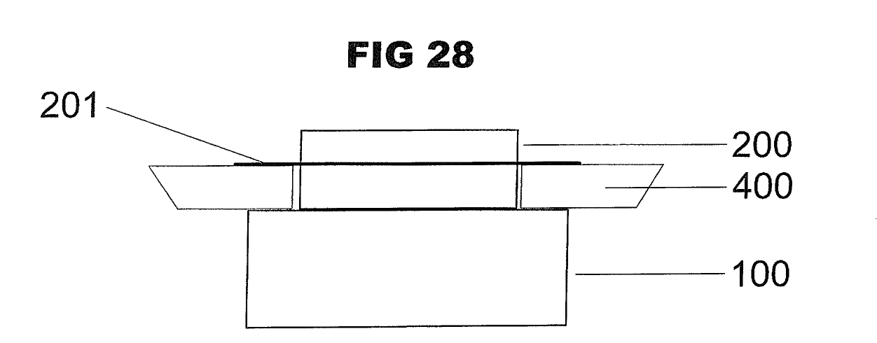

FIG. 28 shows an electrical device 100 in the form of a smoke detector inserted into a box 200 with a flange 201, and attached to a module (not shown).

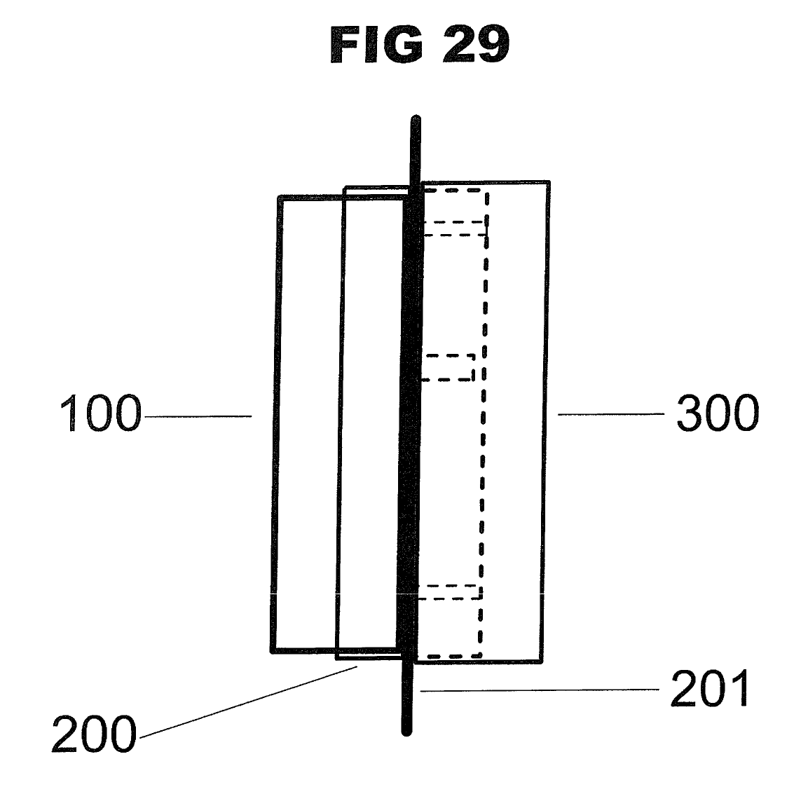

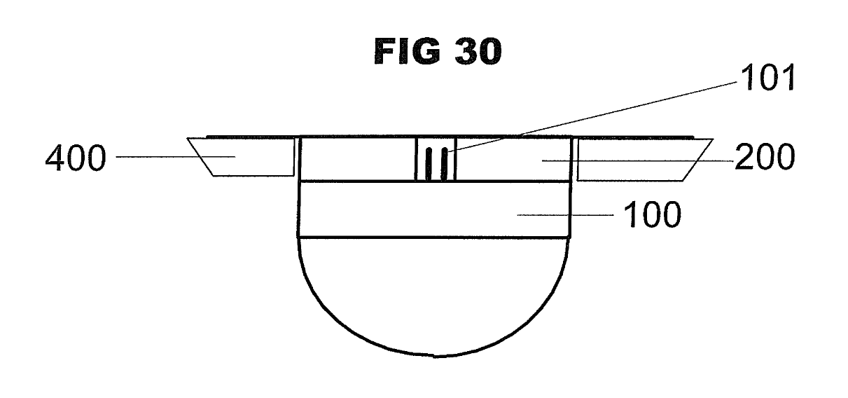

FIG. 29-30 depicts the invention as used during the construction phase of a residential structure to provide construction workers with electricity during construction. FIG. 29 provides construction workers with an electrical outlet. Thus, a cover plate is not necessary. FIG. 30 depicts a simple dome-shaped light fixture used during construction.

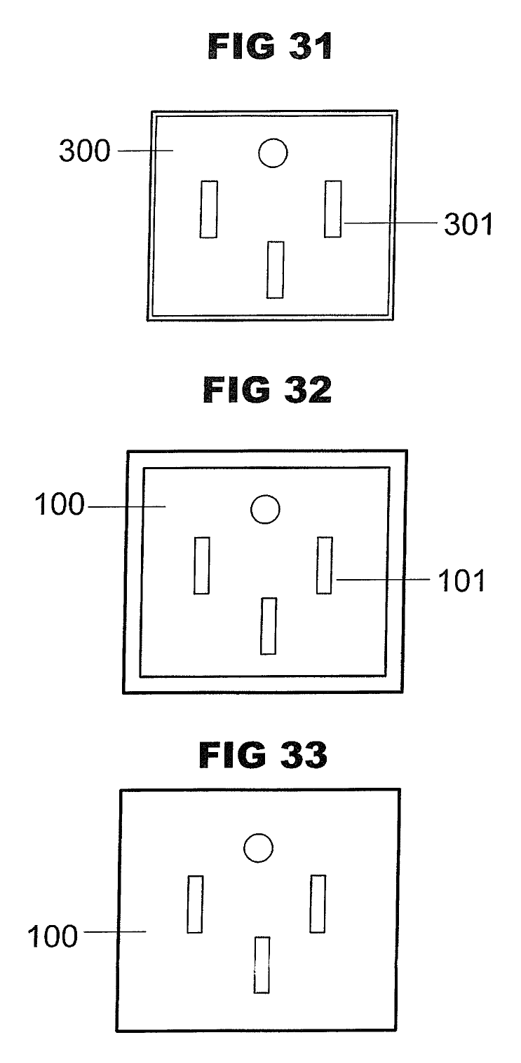

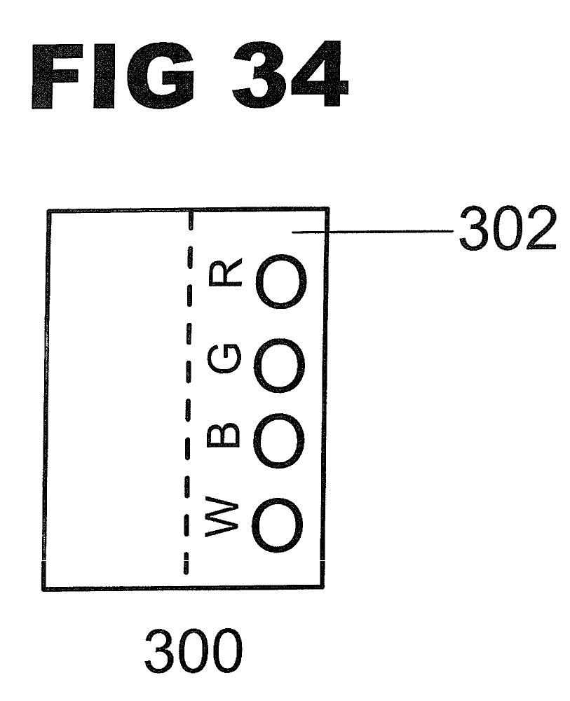

FIGS. 31-32 shows a front and back view of a module used for a 220 volt outlet device for large appliances, such as refrigerators and ranges. FIG. 31 shows four female outlet receptacles, three rectangular shaped and one circular which correspond with male plugs of a 220 volt outlet device (not shown). FIG. 33 is the front view of the 220 volt outlet device into which a large appliance may be plugged. FIG. 34 is a top view of the module for a 220 volt outlet device depicting the location of the stab holes.

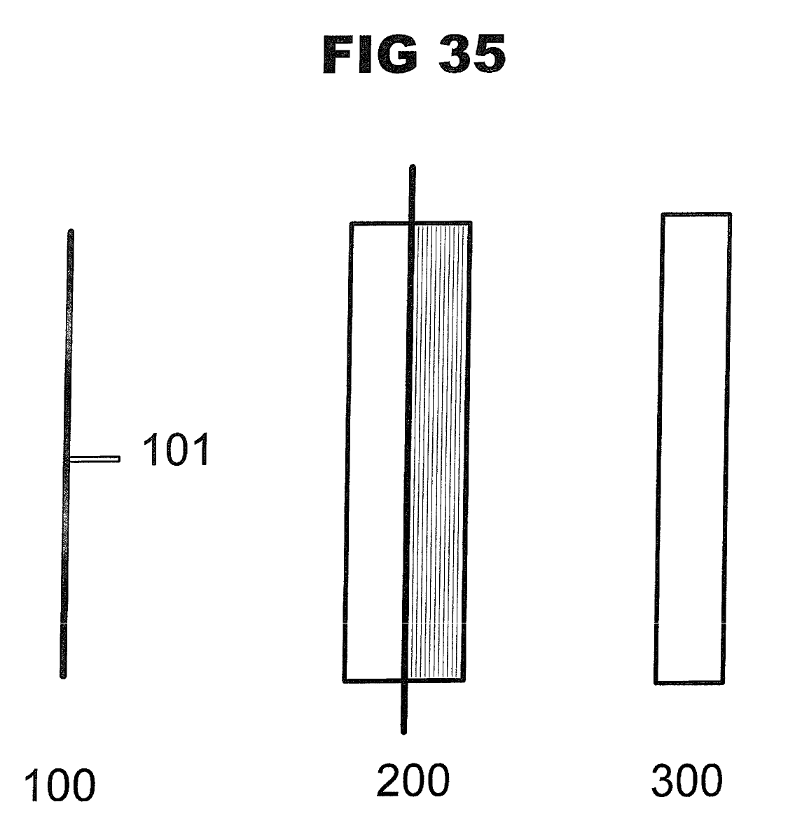

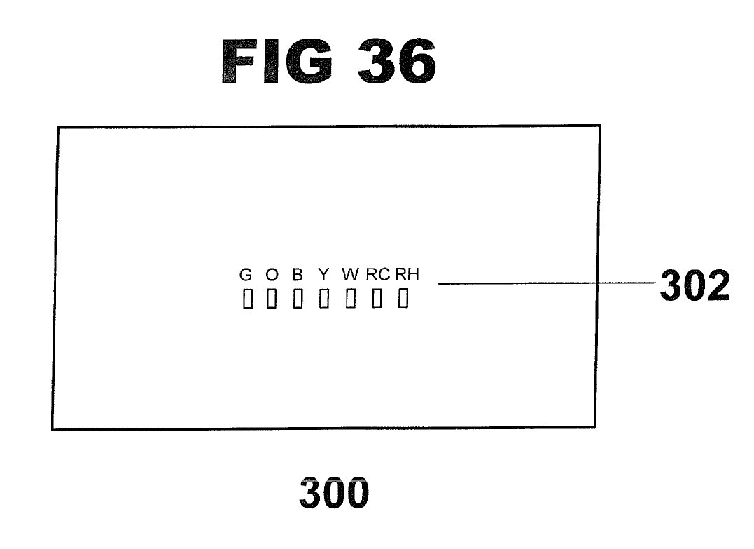

FIG. 35-36 depict the invention in the form of a thermostat outlet. FIG. 35 shows the same basic design as FIG. 1, but with only one set of male plugs 101. The electrical device 100 is not a thermostat itself, but connects to a thermostat. Power-In stab holes 302 are in the back of the module.

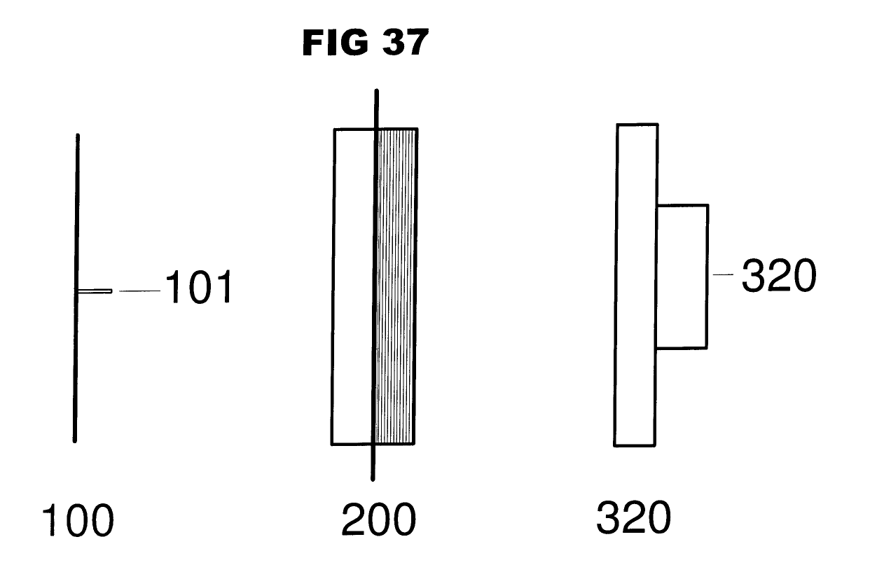

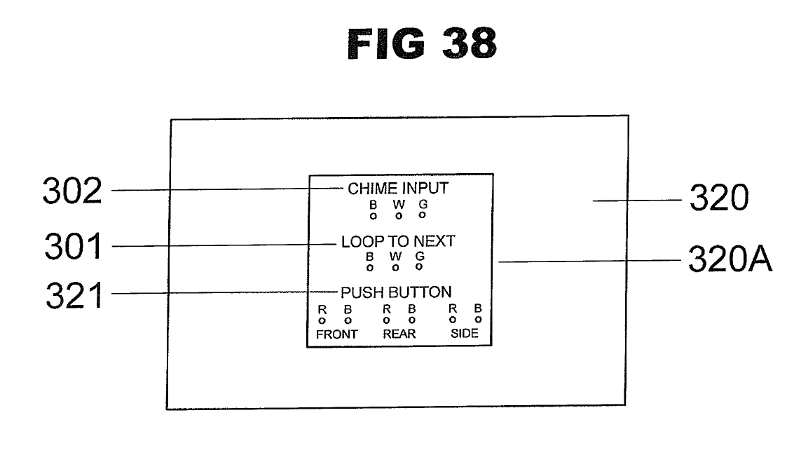

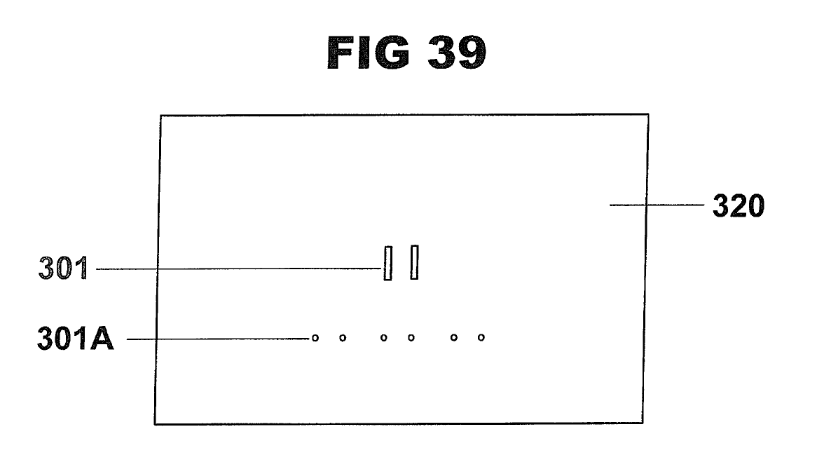

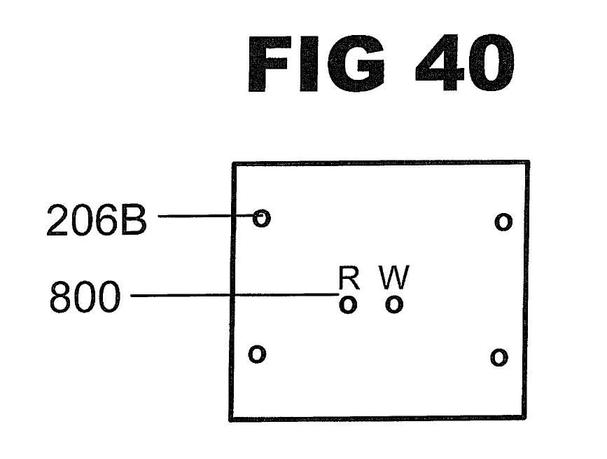

FIGS. 37-40 depicts the invention in the form of a chime box outlet. FIG. 37 shows the same basic design as FIG. 35, except that the module is a transformer module 320, which comprises a transformer 320a in the back of the module. The transformer 320a transforms 120 volt power to low voltage for push buttons. FIG. 38 shows the back view of a transformer module 320, with Power-In stab holes 302, Loop to Next Outlet stab holes 303, and “push button” stab holes. There are three sets of two stab holes for the push buttons; one for the front door bell, one for the back door bell, and one for a side door bell. FIG. 39 shows the front view of a chime module with female outlet receptacles 301a and pushbutton female outlet receptacles 301a. FIG. 40 shows a push button that inserts into the female outlet receptacles 301a and which activate the module when pushed. The push button itself comprises push button stab holes 800.

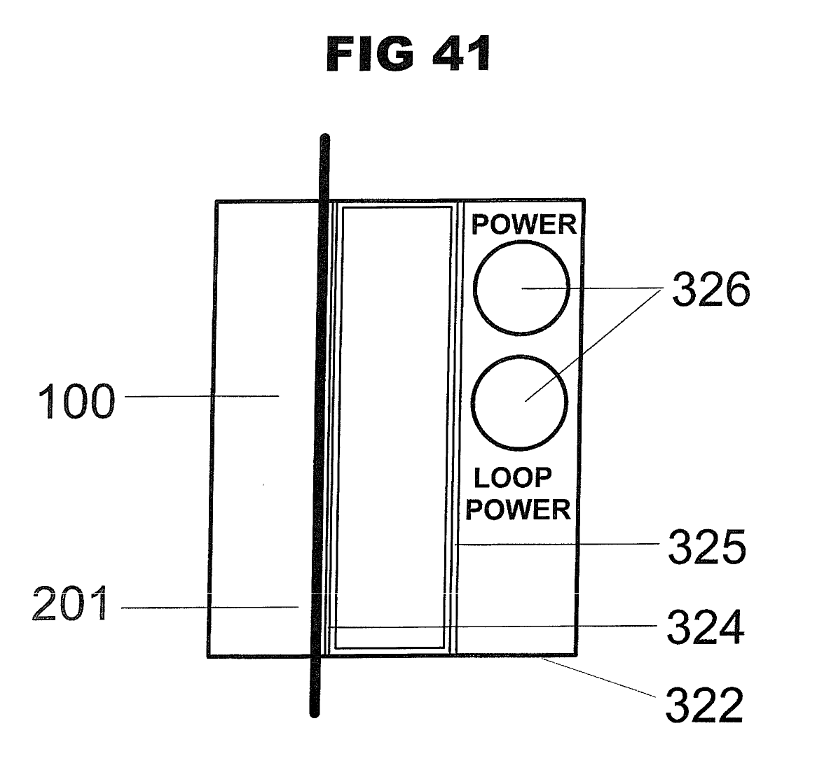

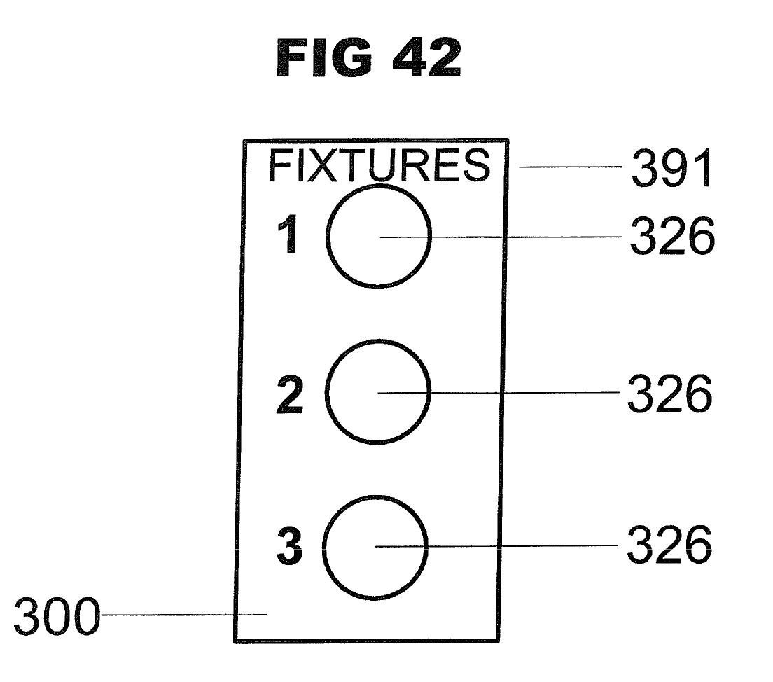

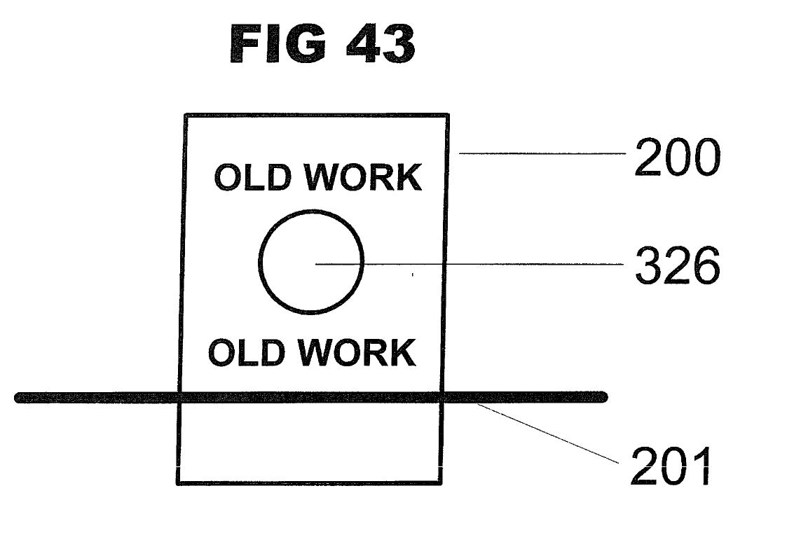

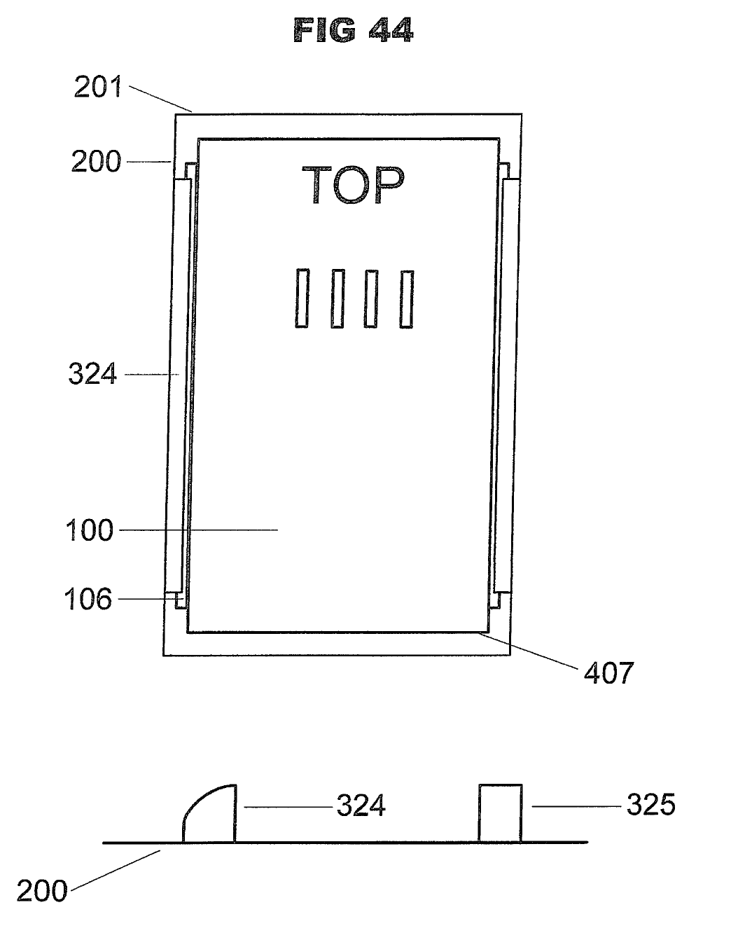

FIGS. 41-44 shows an alternate embodiment of the invention wherein the box comprises only one open side, into which the module is inserted, and the flange is disposed in the front open side of the box. This embodiment of the invention is used for commercial structures. According to FIG. 41, the box comprises an empty space 322 between the back of the module and the back of the box, into which wires are inserted through holes (“knockouts”). FIG. 41 shows two knockouts 326 for “Power” and “Loop Power” on one side of the box. FIG. 42 shows three knockouts 326 for three light fixtures in the rear of the box. FIG. 43 shows another knockout 326 for “Old Work” at the top of the box. Wires enter through these knockouts through conduits and are stabbed into the stab holes of the module. FIG. 41 and FIG. 44 show a front 324 and back 325 stop that locks the module into place, with the empty space in the back of the module defined by the back stop. A spring loaded arm 106 of the electrical device assists to lock the electrical device in place.

What is claimed:

1. A wiring system comprised of an electrical device, a box with two open sides, and a module, wherein the back side of the electrical device comprises at least one male plug and the front side of the module comprises at least one female outlet receptacle, wherein the at least one male plug inserts into the at least one female outlet receptacle through the open sides of the box when the electrical device is joined with the module through one side of the box and the module is joined to electrical device through the other side of the box, wherein the back, top, or bottom sides of the module comprises at least one section comprising at least two stab holes, and wherein at least one female outlet receptacle is continuous with at least one stab hole.

2. The wiring system of claim 1, wherein the electrical device is an outlet, a switch, a lighting fixture, a ceiling fan, a smoke detector, a thermostat, a chime, or a push button.

3. The wiring system of claim 1, wherein the box comprises a flange intersecting the box, with holes for attaching the box to another object, wherein the flange is located in the center, in the front, or in the back of the box, and wherein if the flange is located in the center or the back of the box the holes attach the box to a stud, and if the flange is located in the front, the holes attach the box to a pre-existing box to retrofit the pre-existing box.

4. The wiring system of claim 3, wherein the box comprises ribs for attaching the module and/or the electrical device to the box.

5. The wiring system of claim 3, wherein, in the cases in which the flange is located in the front of the box or in the center, the module inserts over the back portion of the box not occupied by the flange.

6. The wiring system of claim 1, wherein the electrical device comprises a face plate attached to the front side.

7. The wiring system of claim 1, wherein the electrical device has a switch cover plate comprising switches for lighting, a switch outlet, and motion sensors.

8. The wiring system of claim 3, wherein the flange comprises foam insulation attached to its front face to seal drywall openings.

9. The wiring system of claim 1, wherein the front side of the module is hollow, ending with a back wall on the front side of the module comprising the at least one female outlet receptacle.

10. The wiring system of claim 1, wherein the stab holes comprises a copper or aluminum U-channel and a copper or aluminum locking arm and consists of a power-in opening that is either large enough to receive only a #14 gauge wire for a 15 amp circuit, or large enough to receive only a #12 gauge wire for a 20 amp circuit.

11. The wiring system of claim 10, wherein one of the at least two stab holes with a copper or aluminum U-channel and a copper or aluminum locking arm is used for looping wire to another outlet, switch, or light fixture and is large enough to receive only a #14 gauge wire for a 15 amp circuit and large enough to receive only a #12 gauge wire for a 20 amp circuit, and is connected to the power-in opening by a copper or aluminum wire strip.

12. The wiring system of claim 1, wherein the module and the electrical devices are color coded with colors that correspond various modules with various electrical devices, the colors coding being based on the type of module and electrical device, including a 15 amp ARC fault outlet, a 20 amp ARC fault outlet, a 15 amp GFI outlet, a 20 amp GFI outlet, a 15 amp switch, a 20 amp switch, a 15 amp 3-way switch, a 20 amp 3-way switch, a 15 amp 4-way switch, or a 20 amp 4-way switch.

13. The wiring system of claim 1, wherein the at least one female outlet receptacle of the module is positioned to accommodate the at least one male plug of the electrical device in a corresponding position.

14. The wiring system of claim 1, wherein the at least one stab hole accommodate a black wire, a white wire, a ground wire, or a red wire.

15. The wiring system of claim 1, wherein the module is an outlet module whose back side comprises stab holes comprising three sections, namely, a power-in section, a loop-to-next outlet section, and an old work section, each section comprising stab holes for a black wire, a white wire, and a ground wire.

16. The wiring system of claim 1, wherein the module is a switch module whose back side comprises stab holes comprising five sections, namely, a Power-in section, an Old Work section, a To Light 1 section, a To Light 2 section, and a Switch to Outlets section, each section comprising stab holes for a black wire, a white wire, a ground wire.

17. A wiring system for commercial use comprised of an electrical device, a box with an open side, and a module, wherein the back side of the electrical device comprises at least one male plug that insert into the front side of the module comprising at least one female outlet receptacle, wherein the box encloses the module through the open side of the box, wherein the box comprises empty space between the module and the back of the box in which wires may be inserted, wherein the box comprises a hole for connecting a conduit through which wires may enter and exit, wherein the back side of the module comprises at least two stab holes, and wherein the at least one female outlet receptacle of the module is continuous with at least one of the at least two stab holes of the module.

18. The wiring system of claim 17, wherein the electrical device comprises an outlet, a switch, a lighting fixture, a ceiling fan, a thermostat, a chime, a smoke detector, or a push button.

19. The wiring system of claim 17, wherein the box comprises an inside front and back stop for the module, wherein the back stop defines the empty space, and the electrical device has retractable arms that allow the electrical device to insert into the box and hold the electrical device in place.

20. The wiring system of claim 17, wherein the box comprises a front and back stop that locks the module into place.
